(19) United States
(12) Patent Application Publication
(10) Pub. No.: US 2012/0265957 A1
(43) Pub. Date: Oct. 18, 2012

(54) MEMORY MEDIA AND METHOD FOR DATA BACKUP AND RECOVERY

(75) Inventor: CHING-FU LIN, Tu-Cheng (TW)

(73) Assignee: HON HAI PRECISION INDUSTRY CO., LTD., Tu-Cheng (TW)

(21) Appl. No.: 13/156,358

(22) Filed: Jun. 9, 2011

(30) Foreign Application Priority Data
Apr. 18, 2011 (TW) 100113309

(51) Int. Cl. G06F 12/16

(52) U.S. Cl. 711/162; 711/161; 711/E12.103

(57) ABSTRACT

A method is applied for data backup and recovery between an external memory device and an internal memory. A first determination signal is output according to a resistance of the external memory device. The external memory device is switched to electrically connect to the internal memory from a previous state according to the first determination signal. If an operation signal is received, a second determination signal is output. If no operation signal is received, a delay signal is output. Whether the operation signal is a saving operation signal or a recovering operation signal is determined according to the second determination signal. A control signal is output to the internal memory in response to the first determination signal and the operation signal, to control the internal memory reading or writing data to and from the external memory device.

### BACKGROUND

1. Technical Field

The present disclosure relates to memory devices, particularly to a memory media and a method for data backup and recovery.

2. Description of Related Art

Many portable electronic devices, such as mobile phones, often use memory cards to store data. The portable electronic device is usually required to connect to a computer in order to backup data of the portable electronic device, since memory space of the portable electronic device is limited. However, because users do not often bring their computers with the portable electronic devices, data cannot be backed up at any time.

Therefore, it is desirable to have a memory media and a method for data backup and recovery, which can backup and recovery data at any time.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure.

FIG. 1 is a schematic structure of a memory media for data backup and recovery, according to an exemplary embodiment.

FIG. 2 is a functional block diagram of one embodiment of the memory media of FIG. 1.

FIG. 3 is a flowchart of one embodiment of a method for data backup and recovery.

### DETAILED DESCRIPTION

Embodiments of the present disclosure will now be described in detail with reference to the drawings.

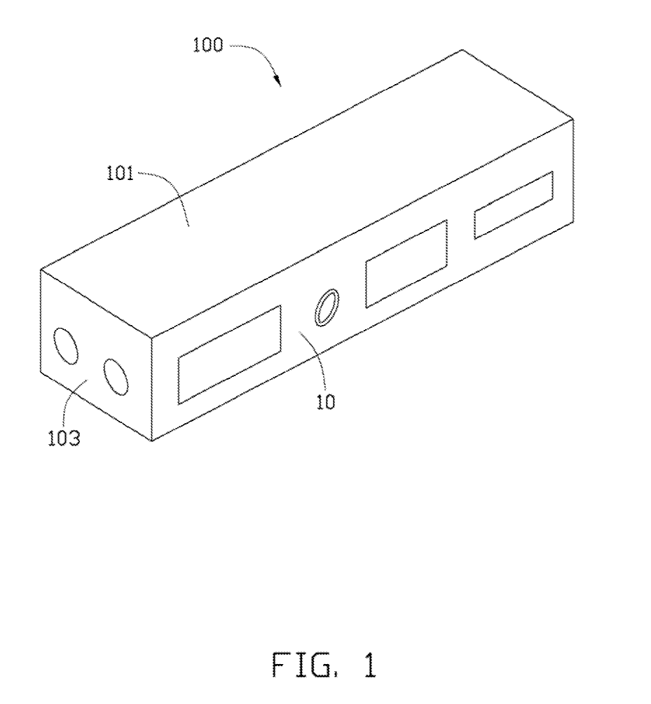

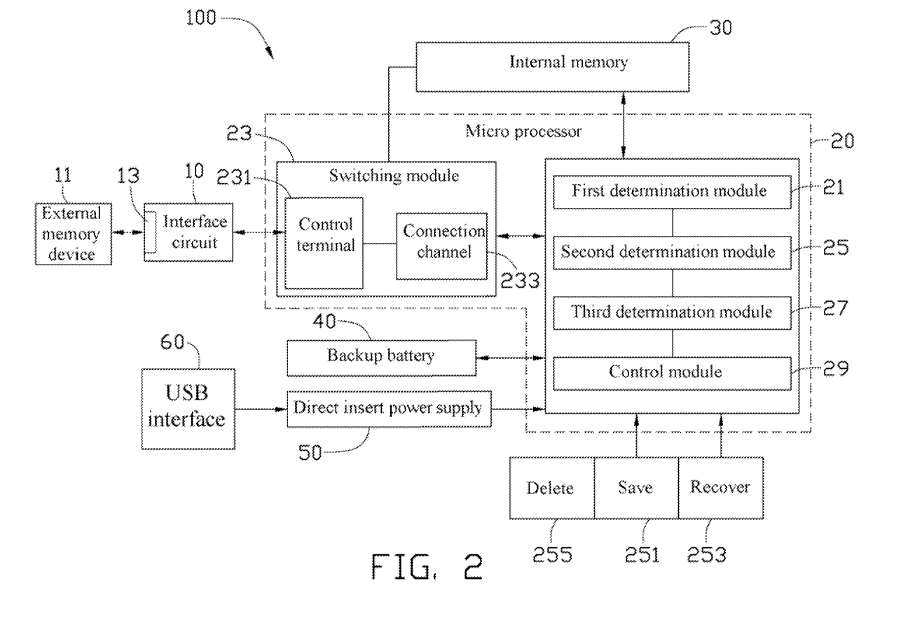

Referring to FIGS. 1 and 2, a schematic structure and a functional block diagram of a memory media 100 for data backup and recovery, according to an exemplary embodiment, are respectively shown. The memory media 100 includes an interface circuit 10, a processor 20, and an internal memory 30. The interface circuit 10 is electrically connected to the internal memory 30 via the processor 20.

In the present embodiment, the memory media 100 comprises a housing 101 that receives the interface circuit 10, the processor 20, and the internal memory 30. The housing 101 defines a touch signal detection area 103, e.g. an area of an LCD touch panel, which is capable of detecting touch signals, such as those from a finger of a person or a stylus. The touch signal detection area 103 is an area of an external surface of the memory media 100 and is in communication with the processor 20 and configured to transmit a number of touch signals to the processor 20.

The interface circuit 10 may be also connected to an external memory device 11, e.g. a MMC card, a SD card, a memory stick, or an XD card, to input data from the external memory device 11. In the present embodiment, the interface circuit 10 includes a number of detection terminals 13 for detecting electronic signals input from the external memory device 11. Because different external memory devices 11 have different resistances, the detection terminals 13 receive corresponding different electronic signals when the different external memory devices 11 are individually connected to the interface circuit 10. Accordingly, the interface circuit 10 outputs different detection signals.

The external memory device 11 also can be other types of memory devices in alternative embodiments.

The processor 20 is configured to process the input data and output a number of control signals to control the memory media 100 to implement corresponding functions. In the present embodiment, the processor 20 executes computerized codes of a first determination module 21, a switching module 23, a second determination module 25, a third determination module 27, and a control module 29 which are prestored in the internal memory 30. Note the modules 21, 23, 25, 27, and 29 comprise computerized code in the form of one or more programs that are stored in the internal memory 30. The computerized code includes instructions that are executed by the processor 20 to provide corresponding functions for modules 21, 23, 25, 27, and 29.

The first determination module 21 is configured to determine a type of the external memory device 11, which is connected to the interface circuit 10, and outputs a first determination signal according to the determination. In the present embodiment, the first determination module 21 determines the type of the external memory device 11 according to the detection signals output from the interface circuit 10. For example, when the interface circuit 10 outputs a signal “A”, the first determination module 21 determines the external memory device 11 to be a MMC card, and then the first determination module 21 further outputs a signal “01”. Similarly, when the interface circuit 10 outputs a signal “B”, the first determination module 21 determines the external memory device 11 to be a SD card, and then outputs a signal “10”. When the interface circuit 10 outputs a signal “C”, the first determination module 21 determines the external memory device 11 to be a memory stick, and then outputs a signal “11”. When the interface circuit 10 outputs a signal “D”, the first determination module 21 determines the external memory device 11 to be an XD card, and then outputs a signal “00”.

The switching module 23 is configured to switch one of the external memory devices 11 to electrically connect to the internal memory 30 from a previous state, according to the first determination signal. The previous state could be, for example, a state not connecting to any one of the external memory devices 11. In the present embodiment, the switching module 23 is a digital switch including a control terminal 231 and a connection channel 233. The control terminal 231 is connected to the interface circuit 10 to receive the first determination signal. The connection channel 233 is configured to connect a corresponding external memory device 11 to the internal memory 30, according to the first determination signal output from the control terminal 231. For example, when the control terminal 231 receives a first determination signal as “01”, the connection channel 233 connects the MMC card to the internal memory 30. Furthermore, in the present embodiment, only one kind of external memory device 11 can be connected to the interface circuit 10 at each time, thus the switching module 23 can correctly connect the corresponding external memory device 11 to the internal memory 30.

The second determination module 25 is configured to determine if an operation signal is input to the processor 20. If an operation signal is input to the processor 20, the second determination module 25 outputs a second determination signal. If no operation signal is input to the processor 20, the second determination module 25 outputs a delay signal. In the present embodiment, the second determination signal includes signals “0” and signals “1”. In detail, the memory media 100 includes an operation interface (not shown), which is defined on the touch signal detection area 103. The operation interface includes a “save” button 251 and a “recover” button 253. When the “save” button 251 is touched by the user, the processor 20 outputs the second determination signal (e.g. signal “1”) to activate a saving function, and when the “recover” button 253 is touched by the user, the processor 20 outputs the second determination signal (e.g. signal “0”) to activate a recovery function.

The third determination module 27 is configured to determine if the operation signal is a saving operation signal or a recovering operation signal, according to the second determination signal. In the present embodiment, when the third determination module 27 receives signal “1” from the second determination module 25, the third determination module 27 determines a saving operation signal is received and an operation will be presented in the next step. When the third determination module 27 receives signal “0” from the second determination module 25, the third determination module 27 determines a recovering operation signal is received and an operation will be presented in the next step.

The control module 29 is configured to output a control signal to the internal memory 30, according to the first determination signal from the first determination module 21 and the operation signal from the third determination module 27. In the present embodiment, the control signal is defined as “reading signal” to control the internal memory 30 to read data from the external memory device 11 or as “writing signal” to control the internal memory 30 to write data to the external memory device 11. When the first determination signal and the saving operation signal are received, the control module 29 outputs the control signal as a “reading signal” to the internal memory 30. When the first determination signal and the recovering operation signal are received, the control module 29 outputs the control signal as a “writing signal” to the internal memory 30. For example, when the first determination signal is “01” while the operation signal is “1”, the control module 29 outputs control signal as a “reading signal” to the internal memory 30 to control the internal memory 30 to read data from the MMC card. When the first determination signal is “01” while the operation signal is “0”, the control module 29 outputs control signal as a “writing signal” to the internal memory 30 to control the internal memory 30 to write data to the MMC card.

The internal memory 30 is a non-volatile memory, such as one or more magnetic disk storage devices, flash memory devices, or other non-volatile solid-state memory devices. The memory space of the internal memory 30 is greater than a total memory space of the different external memory devices 11 or greater than the greatest memory space of the different external memory devices 11. In the present embodiment, the memory space of the internal memory 30 is 128 G. The internal memory 30 includes a number of individual documents, such as documents A, B, C, and D, to individually link the corresponding external memory device 11 thereto and then stores different data. As such, when the interface circuit 10 is connected to a MMC card, the data of the MMC card can be stored in document A, when the interface circuit 10 is connected to a SD card, the data of the SD card can be stored in document B, when the interface circuit 10 is connected to a memory stick, the data of the memory stick can be stored in document C, and when the interface circuit 10 is connected to a XD card, the data of the XD card can be stored in document D.

In different embodiments, the operation interface further includes a “delete” button 255 that can be used to control the processor 20, to delete the data in the internal memory 30.

Moreover, the memory media 100 includes a backup battery 40 and a direct insert power supply 50 connected to the backup battery 40 in parallel. The backup battery 40 and the direct insert power supply 50 are both connected to the processor 20. In the present embodiment, the backup battery 40 can be a lithium cell embedded in the housing 101. The direct insert power supply 50 is connected to an external power source (not shown) via a USB interface 60. It is understood that the USB interface 60 also can be used as a data connector to connect the memory media 100 to a computer. The backup battery 40 and the direct insert power supply 50 can supply power to the memory media 100 to work.

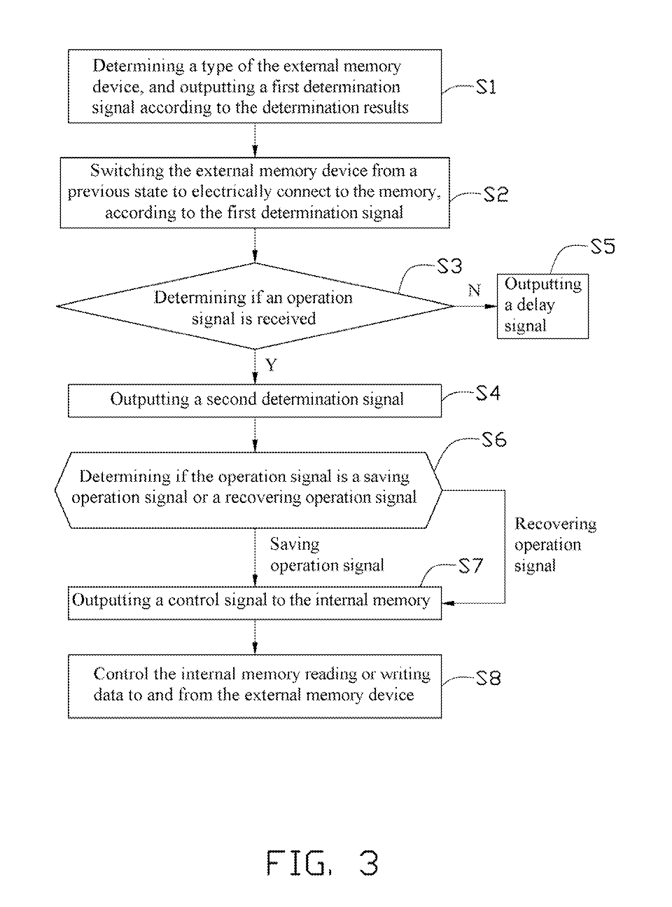

FIG. 3 is a flowchart of a method for data backup and recovery, according to another exemplary embodiment. It should be understood that additional steps may be added, others deleted, or the ordering of the steps may be changed depending on the embodiment. A number of steps of the method are implemented by the memory media 100, as following:

In step S1, a type of the external memory device 11, which is connected to the interface circuit 10 is determined, and a first determination signal is output. In the present embodiment, the type of the memory device is determined according to one of the different detection signals output from the interface circuit 10.

In step S2, the external memory device 11 is switched to electrically connect to the internal memory 30, according to the first determination signal. For example, when a first determination signal as “01” is received, the MMC card is connected to the internal memory 30. In the present embodiment, only one kind of external memory device 11 can be connected to the memory media 100 at each time, thus the corresponding external memory device 11 can be correctly connected to the internal memory 30.

In step S3, if an operation signal is determined to be input to the processor 20, a step S4 is implemented as: outputting a second determination signal. If there is no operation signal input to the processor 20, a step S5 is implemented as: outputting a delay signal. In the present embodiment, the second determination signal includes signals “0” and signals “1”. In detail, the memory media 100 includes an operation interface which is defined on the touch signal detection area 103. The operation interface defines a “save” button 251 and a “recover” button 253. When the “save” button 251 is touched by the user, the processor 20 outputs the second determination signal (e.g. signal “1”) to activate a saving function, and when the “recover” button 253 is touched by the user, the processor 20 outputs the second determination signal (e.g. signal “0”) to activate a recovery function.

In step S6, determining if the operation signal is a saving operation signal or a recovering operation signal, according to the second determination signal. When a signal “1” is received, a saving operation signal is determined and a saving operation will be presented in the next step. When a signal “0” is received, a recovering operation signal is determined and a recovering operation will be presented in the next step.

In step S7, a control signal is output to the internal memory 30, according to the first determination signal and the operation signal. In the present embodiment, the control signal is defined as “reading signal” to control the internal memory 30 to read data from the external memory device 11, or is defined as “writing signal” to control the internal memory 30 to write data to the external memory device 11. When the first determination signal and the saving operation signal are received, the control signal as a “reading signal” is output to the internal memory 30. When the first determination signal and the recovering operation signal are received, the control signal as a “writing signal” is output to the internal memory 30. For example, when the first determination signal is “01” while the operation signal is “1”, the internal memory 30 is controlled to read data from the MMC card. When the first determination signal is “01”, while the operation signal is “0”, the internal memory 30 is controlled to write data to the MMC card.

In step S8, a data transmission between the external memory device 11 and the internal memory is implemented, according to the control signal.

It will be understood that the disclosed embodiments are shown and described by way of illustration only. The principles and the features of the present disclosure may be employed in various and numerous embodiment thereof without departing from the scope of the disclosure. The above-described embodiments illustrate the scope of the disclosure but do not restrict the scope of the disclosure.

What is claimed is:

1. A memory media connected to an external memory device, comprising:
memory;
one or more processors;
one or more modules stored in the memory and configured for execution by the one or more processors, the one or more modules comprising:
a first determination module outputting a first determination signal according to a resistance of the external memory device;
a switching module switching the external memory device from a previous state to electrically connect to the memory, according to the first determination signal;
a second determination module outputting a second determination signal in response to determining that an operation signal was input to the one or more processors, and in response to determining that no operation signal is input to the one or more processors, the second determination module outputs a delay signal;
a third determination module determining if the operation signal is a saving operation signal or a recovering operation signal according to the second determination signal; and
a control module outputting a control signal to the memory according to the first determination signal and the operation signal, to control the memory reading or writing data to and from the external memory device.

2. The memory media of claim 1, further comprising a housing defining a touch signal detection area capable of detecting touch signals on the touch signal detection area, the touch signal area is in communication with the one or more processors and configured to transmit a plurality of touch signals to the one or more processors.

3. The memory media of claim 2, further comprising an interface circuit electrically connecting the external memory device to the memory via the one or more processors, wherein the memory is an internal memory of the memory media.

4. The memory media of claim 3, wherein when different external memory devices are individually connected to the interface circuit, the interface circuit individually receives different electronic signals from the external memory devices, and the interface circuit further outputs different detection signals to the first determination module, the first determination module determines type of the external memory device according to one of the different detection signals.

5. The memory media of claim 3, wherein the switching module is a digital switch comprising a control terminal and a connection channel, the control terminal is connected to the interface circuit to receive the first determination signal, and the connection channel is controlled to connect a corresponding external memory device to the internal memory by the first determination signal.

6. The memory media of claim 3, wherein only one external memory device can be connected to the interface circuit at each time.

7. The memory media of claim 3, wherein the memory media comprises a save button and a recover button configured on the touch signal detection area, when the save button is touched by the user, the one or more processors output the second determination signal to activate a saving function saved in the internal memory, and when the recover button is touched by the user, the one or more processors output another second determination signal to activate a recovery function saved in the internal memory.

8. The memory media of claim 7, wherein when the third determination module receives a signal “1” from the second determination module, the third determination module determines that a saving operation signal is received, when the third determination module receives a signal “0” from the second determination module, the third determination module determines that a recovering operation signal is received.

9. The memory media of claim 3, wherein the control signal is defined as a reading signal to control the memory to read data from the external memory device, or is defined as a writing signal to control the internal memory to write data to the external memory device.

10. The memory media of claim 3, wherein the memory space of the memory is greater than a total memory space of the different external memory devices or greater than the greatest memory space of the different external memory devices.

11. The memory media of claim 3, wherein the internal memory comprises a plurality of individual documents to individually link the corresponding external memory device.

12. The memory media of claim 1, wherein the memory media comprises a backup battery and a direct insert power supply connected to the backup battery in parallel, and the backup battery and direct insert power supply both are connected to the one or more processors, the direct insert power supply is connected to an external power source via a USB interface.

13. A method for data backup and recovery between an external memory device and an internal memory, comprising:
determining a type of the external memory device according to a resistance of the external memory device, and outputting a first determination signal according to the determination;
switching the external memory device from a previous state to electrically connect to the memory, according to the first determination signal;
determining if an operation signal is received, and if operation signal is received, outputting a second determination signal, if no operation signal is received, outputting a delay signal;
determining if the operation signal is a saving operation signal or a recovering operation signal according to the second determination signal; and
outputting a control signal to the internal memory according to the first determination signal and the operation signal, to control the internal memory reading or writing data to and from the external memory device.
